(19) United States
(12) Patent Application Publication
(10) Pub. No.: US 2012/0290372 A1
(43) Pub. Date: Nov. 15, 2012

(54) DIGITAL COMMUNICATION MANAGEMENT SYSTEM

(75) Inventors: Daniel Lewis Alexander, New York, NY (US); Jason Buckingham Chen, Alexandria, VA (US)

(73) Assignee: WeatherAlpha, LLC, Alexandria, VA (US)

(21) Appl. No.: 13/555,494

(22) Filed: Jul. 23, 2012

Related U.S. Application Data
(63) Continuation of application No. 13/253,957, filed on Oct. 5, 2011.
(60) Provisional application No. 61/344,784, filed on Oct. 5, 2010.
(60) Provisional application No. 61/344,904, filed on Nov. 10, 2010.

(51) Int. Cl. G06Q 30/02

(52) U.S. Cl. 705/14.5

(57) ABSTRACT

A system for targeting contextually relevant digital communications based on past, current, or forecasted weather conditions is disclosed. The system receives passive location information from a viewer and a real-time feed of weather information from a weather database. The disclosed system assesses the weather condition in a given location and then manages the display and rotation of advertisements with both direct and indirect weather dependencies.

### CROSS REFERENCES TO RELATED APPLICATIONS

This application is a continuation of U.S. application Ser. No. 13/253,957, filed Oct. 5, 2011, which claims priority to U.S. Provisional Application No. 61/344,784, filed on Oct. 5, 2010, and U.S. Provisional Application No. 61/344,904, filed on Nov. 10, 2010, the disclosure of each of which is incorporated herein by reference.

### FIELD OF INVENTION

The technology relates to the field of targeting contextually relevant communications.

### BACKGROUND

Carefully timing and targeting the display of advertisements allows marketers to increase conversion rates and reduce overall advertising expenditures. In addition to tailoring advertisements to particular populations or individuals, conversion rates may be further improved by targeting the population or individual at a time when they are most likely to respond to the advertisement. For example, consumers are more likely to respond to an advertisement if it relate to their current environment (including current atmospheric conditions). Rather than blanketing a country or region with randomly selected advertisements, advertisers may improve conversion rates by carefully targeting a narrow audience with contextually relevant communications.

Weather conditions in a given location can play an important role in creating demand for goods and services. Several economic studies have shown the impact of weather on macroeconomic spending (e.g., a warm spring over the Continental United States results in greater aggregate sales of short pants) as well as microeconomic impacts (e.g., a snowstorm over New York City will result in increased local sales of goods such as snow blowers, firewood, ice melters, etc.).

Since weather affects consumer's physical needs, psychological and emotional moods and purchasing habits, weather information may be used to improve advertisement targeting. In addition, the dynamic and interactive nature of the internet allows for enhanced targeting based on information obtained about consumers.

Many ad networks, advertisers and ad agencies conduct “seasonal” ad campaigns. That is, advertisements that relate broadly to seasonal weather. Such advertisements run for a few months at a time. In addition, they may prepare advertisements for specific weather condition(s), but have no ability to display and rotate them before, during or after the occurrence of that weather condition(s). To illustrate with a hypothetical example, Acme Automobile Co. creates a digital advertisement with a plain cool blue background and a crop art snow flake falling, and displays the advertisement at any time between December and February (for the Northern Hemisphere).

It may be helpful to include more specific weather-related information, but such specificity is problematic: the advertiser does not know when such detailed weather-related information will be relevant to a particular viewer at a particular location. Using weather data to improve the accuracy of advertisement targeting faces at least two major problems: both weather and consumers are moving targets. Weather patterns are constantly changing, and in addition, consumers are constantly moving. Furthermore, absolute weather conditions are often less important to consumer spending decisions than the weather's divergence from the consumer's weather expectations.

It is challenging to identifying the particular weather condition affecting a viewer of a digital display device quickly enough to display and rotate relevant digital communications based on the weather.

### SUMMARY

The Digital Communication Management System (DCMS) provides a method for dynamically selecting, rotating or altering digital advertisements based on constantly changing weather conditions, thereby allowing advertisers to include weather specific details and improve the contextual accuracy in targeting such advertisements. Using the DCMS, marketers can create advertisements correlating to specific weather conditions, and reliably display them to users shortly before, during or shortly after the occurrence of that weather condition. Using the DCMS in our hypothetical, Acme Auto can now create a digital advertisement that includes sleet and freezing rain in the artistic content of the ad, and a message for a viewer in Washington D.C. that says “Acme Auto's AWD system keeps you glued to the road, despite the icy roads in Washington D.C.” and display the advertisement only when the icy weather just occurred, is occurring, is about to occur, or is otherwise contextually relevant to the viewer.

The DCMS analyzes viewer information and weather information to facilitate the display of contextually relevant digital communications. It may be embodied in a stand-alone platform, or as an add-on application to an existing digital communication system. The DCMS may be used by websites, advertisement networks or other entities that display and cycle digital advertisements. The DCMS may combine real-time information about the viewer's location with weather information to manage the display and rotation of digital advertisements. By using weather conditions as a triggering mechanism, the DCMS displays and cycles digital advertisements relevant to the viewer's current, forecasted, or past weather conditions for any geographic location in the world.

The DCMS can be used to display communications in any digital medium, including, without limitation, websites, televisions, digital billboards, and mobile device applications. The DCMS can be used to display and cycle digital communications associated with current, forecasted, or past atmospheric and environmental conditions affecting the viewer.

Current atmospheric state may be defined by a variety of numeric or nominal attributes. Numeric attributes include, without limitation, temperature, wind speed, wind direction, dew point, or fractional sky cover. Notional attributes include, without limitation, existence of precipitation, if the sun is shining, and the precipitation type (e.g. rain, snow, or other precipitation types).

When a viewer visits a website or webpage, for example, the DCMS automatically collects weather information for the viewer's current location. Such information may pertain to current weather (present), forecasted weather (future), or recently occurring weather (past).

The DCMS sorts collected weather information into discrete variables and passes the data through a plurality of rule-based logical arguments. The rules form a decision tree that allows at least three different methods for displaying and cycling advertisements. In a preferred embodiment, these methods include: (a) weather event advertising, (b) temperature abnormality advertising, and (c) seasonal advertising. Such methods may be prioritized based on the user preference.

Such advertising methods may consist of thresholds used to determine which advertisements are appropriate to display based on the particular consumer's location.

The end points, or nodes, of the decision tree are either weather-relevant digital communications to be displayed or weighted factors to be considered in a broader advertisement targeting analysis. Such communications may include, without limitation: (a) advertisements of businesses and/or their products and/or services that are relevant to a viewer's local, past, current or (b) forecasted weather conditions, digital advertisements for businesses and/or their products and/or services that have no direct or obvious relevance to the viewer's weather, but are preferred to be displayed during certain weather conditions. The DCMS may operate as a stand-alone platform to manage the rotation and display of digital advertisements, or it may work in conjunction with another advertising platform, for example, as an add-on, plugin, or extension application.

The DCMS may continue to collect and process the weather data feeds and account for changes to past, current, or forecasted weather conditions for that location and adjust the display and rotation accordingly.

### BRIEF DESCRIPTION OF THE DRAWINGS

FIG. 1 illustrates a relationship diagram outlining the overall architecture of the Digital Communication Management System.

FIG. 2 illustrates an overview of the weather advertising decision process.

FIG. 3 illustrates an overview of the advertisement selection process as determined by current weather events involving precipitation.

FIG. 4 illustrates an overview of the advertisement selection process as determined by current weather events not involving precipitation.

FIG. 5 illustrates an overview of the advertisement selection process as determined by current temperature or dew point anomalies.

FIG. 6 illustrates an overview of the advertisement selection process as determined by forecasted weather conditions.

FIG. 7 illustrates an overview of the advertisement selection process as determined by past weather conditions.

FIG. 8 illustrates an example advertisement as triggered by currently falling snow.

### DETAILED DESCRIPTION AND PREFERRED EMBODIMENT

The following is a detailed description of exemplary embodiments. The embodiments are provided to illustrate aspects of the invention and should not be construed as limiting the scope of the invention. A list of defined terms is provided first to facilitate understanding of the invention.

“Consumer” or “viewer” means the intended recipient of the advertisement.

“Advertisement” means any type of digital communication capable of being sent to a digital device for display.

“User” means the person, entity or system operating the DCMS on behalf of an advertiser or communication-sender.

“Geolocation information” is any information capable of identifying the probable geographic location of a digital display or communication device. Although precise location information is helpful, it is not necessary. Geolocation information need not include location data; it is sufficient that the information is capable of identifying location through cross referencing a database. A device's IP address, for example, may be used to identify the devices geolocation through a traceroute, ping, or other commonly known method.

“Passive geolocation information” is any geolocation information that is not entered manually by a viewer. It excludes, for example, information entered by a consumer into a text box or drop down menu. A device's IP address, for example, is passive geolocation information.

“Recent weather data” includes weather data from a plurality of hours preceding the time at which the communication is being selected. It includes weather information that is still likely to be in a consumer's recent memory or affecting the consumer's current environment.

“Climatological data” includes weather data from a period of several years. Climatological data affects a consumer's weather expectations, and whether a particular weather condition is normal or unexpected for a given geolocation, season, and time of day.

“Weather conditions” mean any atmospheric condition capable of detection and measurement.

“Degrees” means “degrees Fahrenheit” unless specifically defined otherwise. The system is not limited to functioning in units of degrees Fahrenheit.

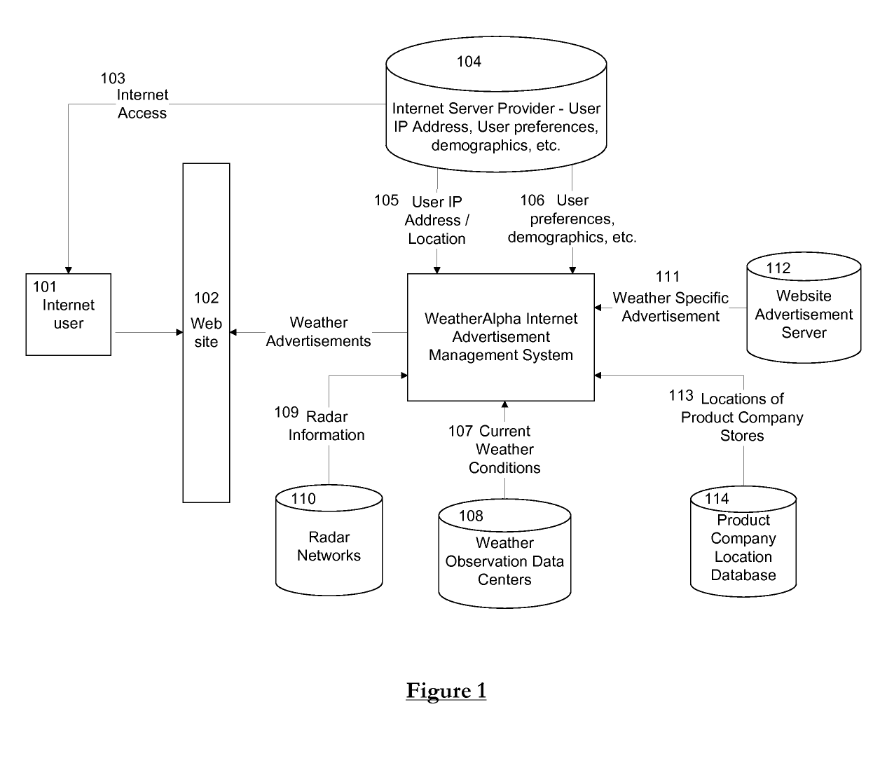

FIG. 1 illustrates an overview of a preferred embodiment. The DCMS receives (a) geolocation information, (b) weather data at or near the location, and (c) a series of potential advertisements.

The embodiment illustrated in FIG. 1 includes receiving information from a viewer 101 and that viewer's connection to a website 102. The viewer's internet access 103 is provided by an Internet Service Provider (ISP) 104. From this ISP, information about viewer location may be obtained from the IP address of the viewer 105. In some embodiments, additional viewer demographic and/or geographic information is provided through a tracking cookie or similar external system.

In a preferred embodiment, the weather data includes long term climatological information, recently transpired weather data, current weather data and predicted future weather data. This data feed may be provided by one or more weather information databases 108. The DCMS may access radar systems to obtain more precise information related to falling precipitation 110. Unlike recent, current and predicted weather data, Long term weather data (climatological data) does not change on a daily basis. Climatological data may either be stored locally, or accessed from a remote database. In a preferred embodiment, climatological data is indexed by season (“seasons” may be broken down into units more detailed than “spring” “summer” “fall” “winter). Climatological data may be (a) indexed by time of day, or (b) adjusted on the fly to account for weather events that have a probability of occurrence correlating to a time of day, or (c) unadjusted and unindexed by time of day.

The DCMS ranking algorithm uses the relevant weather data to select a contextually appropriate advertisement. Once all relevant data concerning the viewer's location, viewer information, and local weather have been obtained and processed by the DCMS, a weather specific advertisement 111 is retrieved from a database 112 or advertisements sorted by various weather categories.

In a preferred embodiment, the DCMS may use the location information to identify nearby location(s) where the advertised product or service is available for purchase.

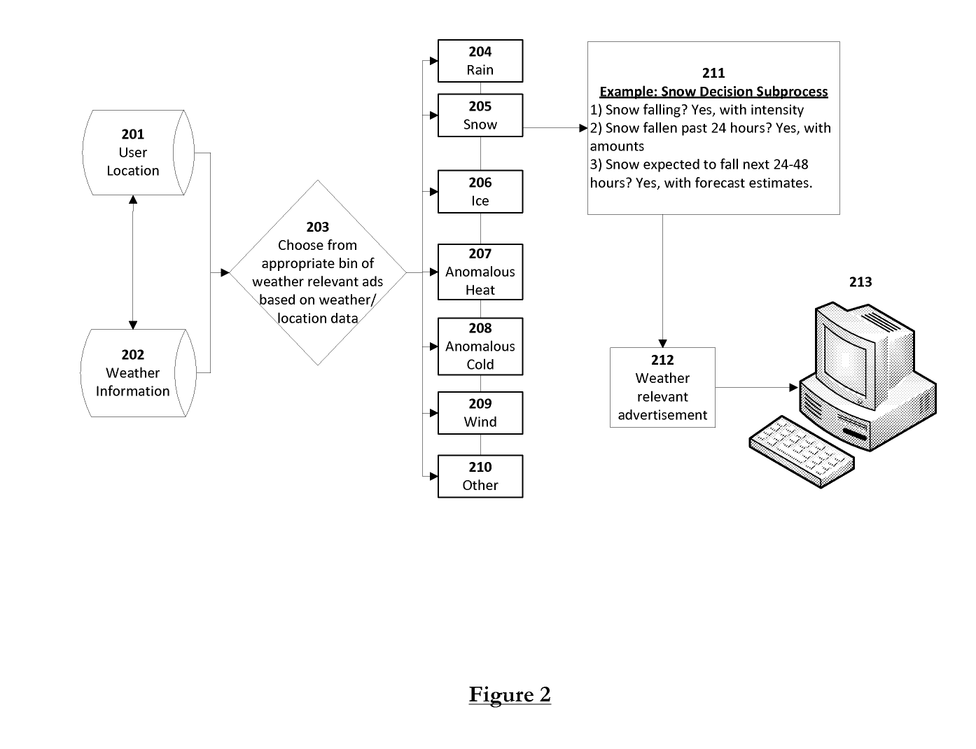

FIG. 2, which is an expanded version of components 111 and 112 in FIG. 1, outlines the process by which advertisements are selected based upon current, forecasted, or past weather conditions. Upon collection of viewer location 201 and local weather information 202, the DCMS analyzes the results 203 and looks for certain weather conditions, including, without limitation, rain 204, snow 205, ice 206, anomalous heat 207, anomalous cold 208, or wind 209. Other 210 possible weather conditions of note include (but are not limited to) thunder, high wind, fog, high or low humidity, among other criterion.

In addition to identifying past, current, or forecasted weather conditions, the DCMS may also evaluate the magnitude of the weather condition and compare it to the condition's normal magnitude for that location. The same type of weather condition may cause a different psychological consumer response depending on its magnitude. For example, in a preferred embodiment, once falling snow is detected, the DCMS processes a series of yes/no queries based on numeric thresholds to determine whether the snow event is light, moderate, or severe/heavy in intensity. For instance, 3 inches of snow in Atlanta will likely create a higher demand for snow-related products than 3 inches of snow in Minneapolis, where average snowfall is much greater and residents are familiar with such weather conditions.

As shown with the snow example, the DCMS has the capability to identify the magnitude of each current, forecasted, or past weather condition(s). Using threshold analysis, such magnitude considerations will be important for almost any weather condition, such as, but not limited to, rain, snow, freezing rain, sleet, hail, heat, cold, and wind. The preferred embodiment distinguishes between varying levels of precipitation intensity; record heat/cold versus simply anomalous heat/cold; etc. However, magnitude may not be particularly important for some digital communication-triggers (i.e., the same advertisement would likely appear during times of light freezing rain as would during moderate or heavy freezing rain).

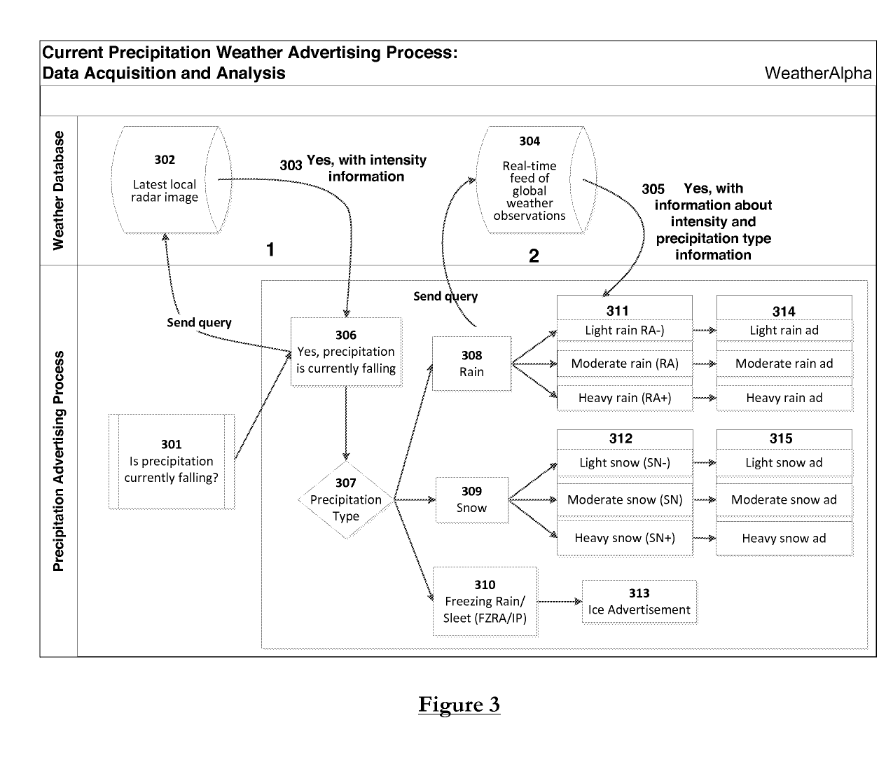

FIG. 3 depicts the process of displaying digital advertisements based on current precipitation. To answer the question of whether precipitation is falling 301 the DCMS may check multiple sources if necessary. For instance, if the first source is the local radar image from the NWS 302, when matched to the viewer's location, it can identify positive echoes as falling precipitation as well as corresponding precipitation intensity 303 based on the color of the echoes themselves. However, since radar images are sometimes cluttered with false echoes, the DCMS may determine that it is best to confirm the existence of falling precipitation by analyzing data collected from a nearby observation station 304. From this real-time data feed, information about precipitation intensity and type is also obtained 305 for the consumer's location.

If the existence of ongoing precipitation is confirmed through radar data, observation data, or both, a sub-process 306 is triggered to discern type 307 and intensity 311, 312. For rain 308 and snow 309 precipitation types, light, moderate and heavy rates of precipitation 311, 312 may also be sorted by their METAR codes (RA−, RA, RA+ for light, moderate and heavy rain while SN−, SN, SN+ denote light, moderate, and heavy snow, respectively). Such sorting is used to trigger custom advertisements 314, 315 corresponding to the intensity of the rain or snow. Note that changes in precipitation intensity do not necessarily change the type of advertisement displayed. There may be considerable overlap in types of weather conditions covered by a given advertisement (for example, a snow blower advertisement might run during times of both moderate and heavy snow). In addition, weather conditions may be prioritized by the user of the DCMS. All forms and intensity of ice 310 (freezing rain or sleet, denoted in the METAR as FZRA and IP, respectively) are used to trigger ice advertisements 313.

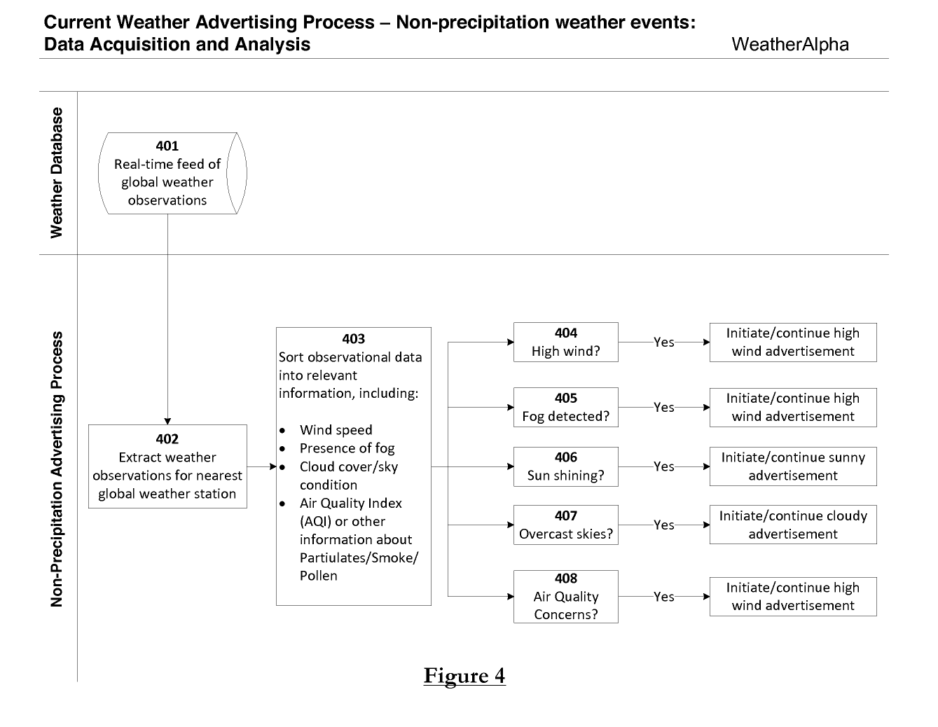

FIG. 4 shows triggering mechanisms for current non-precipitation weather events. In one embodiment, non-precipitation weather event factors are weighed by priority, from high to low: high wind, fog, sunshine, cloudiness, and air quality. From a real-time feed of global weather observations 402, the DCMS extracts information 403 relevant to such events. As with precipitation advertisements, each non-precipitation weather event is triggered by quantitative or qualitative thresholds. High wind speed would be used to trigger a wind advertisement 405, fog with low visibility is used to trigger a fog advertisement 406, fractional sky cover for sunshine advertisements 407 and cloudiness advertisements 408, and presence of various particulates for relevant air quality advertisements 409.

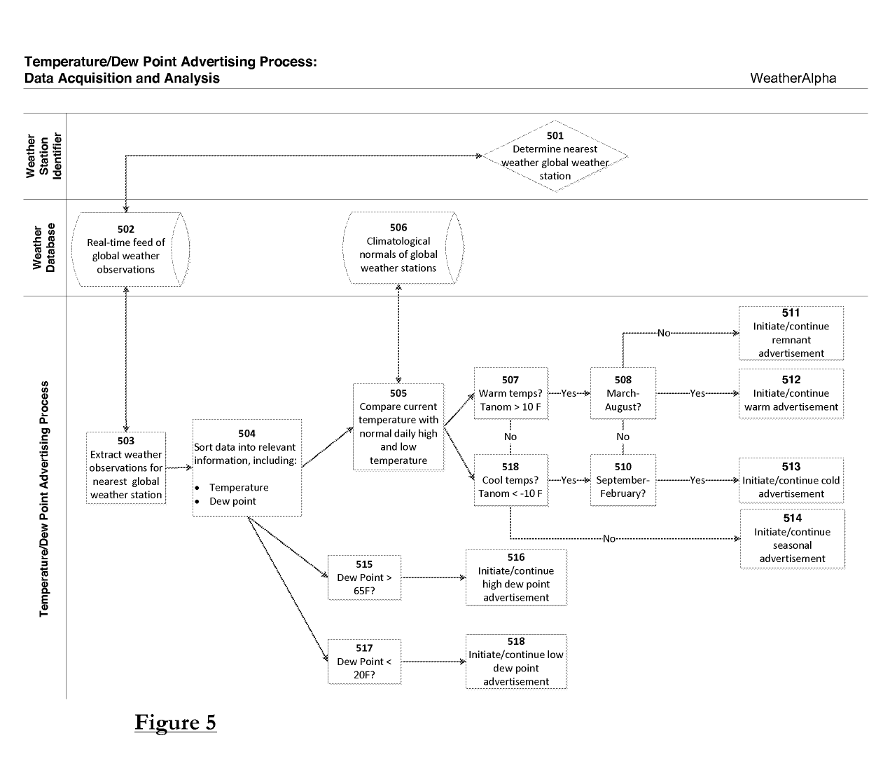

FIG. 5 outlines the steps involved in displaying advertisements in an embodiment based on current temperature and dew point anomalies. A preliminary step in the Temperature Advertising Process—and all triggering processes—is the identification of the nearest observation station to the viewer's IP address 501. Once such proximate weather observation data have been extracted 503 from a global feed of weather observations 502, data is sorted into two discrete elements, temperature and dew point 504. The temperature is then compared 505 to normal climatological temperature for that hour (or day) 506 to determine whether there is a positive 507 or negative 509 temperature anomaly, Tanom (Tanom=Tc−Tn, Temp. anomaly=current temperature minus normal temperature).

In a preferred embodiment, warm temperature anomalies 507 occur when the current temperature is at least 5-10 degrees warmer than normal, and cold temperature anomalies 509 occur when the current temp is at least 5-10 degrees colder than normal. In other embodiments, these thresholds are modified to align with customer preference and/or statistical analysis for a given location's historical temperature trends.

Instances of warm temperature anomalies may be further screened by the month of the year. Warm advertisements are displayed 512 if the date falls in the spring or summer months 508 (the typical spring and summer months depend on if the viewer is in the northern or southern hemisphere). The reason for this is because a warm anomaly in the warm season might have more impact on consumer response than a warm anomaly during the cold season. For instance, a 100 degree day in New York in July when the normal high is 85 might have a greater impact than when it is 55 degrees in January, the same 15 degrees above the normal high of 40. The same logic applies to cold advertisements, which are only initiated 513 during the fall and winter months 510 (the typical fall and winter moths depend on if the viewer is in the northern or southern hemisphere). If neither warm 507 nor cold 509 conditions are met, a seasonal advertisement 514 appears. Moreover, if an anomaly occurred that wasn't seasonally appropriate, a remnant advertisement could appear 511 based on the user's preferences.

Instances of warm temperature anomalies may be further screened by the month of the year. Warm advertisements are displayed 512 if the date falls in the spring or summer months 508 (the typical spring and summer months depend on if the viewer is in the northern or southern hemisphere). The reason for this is because a warm anomaly in the warm season will have more impact on consumer response than a warm anomaly during the cold season. For instance, a 100 degree day in New York in July when the normal high is 85 will have a greater impact than when it is 55 degrees in January, the same 15 degrees above the normal high of 40. The same logic applies to cold advertisements, which are only initiated 513 during the fall and winter months 510 (the typical fall and winter moths depend on if the viewer is in the northern or southern hemisphere). If neither warm 507 nor cold 509 conditions are met, a seasonal advertisement 314 appears. Moreover, if an anomaly occurred that wasn't seasonally appropriate, a remnant advertisement would appear 511.

After the DCMS has analyzed the current temperature data, it will search for dew point thresholds. A high dew point value 515 would trigger a humid advertisement 517. A low dew point value 516 would trigger a dry advertisement 518. In a preferred embodiment, a point value 515>65F would trigger a humid advertisement 517, and a dew point value 516<20 F would trigger a dry advertisement 518. Depending on the geographic location, high and low dew point values may be set by the frequency of such dew point occurring at the given time, day and geographic location, based on climatological norms.

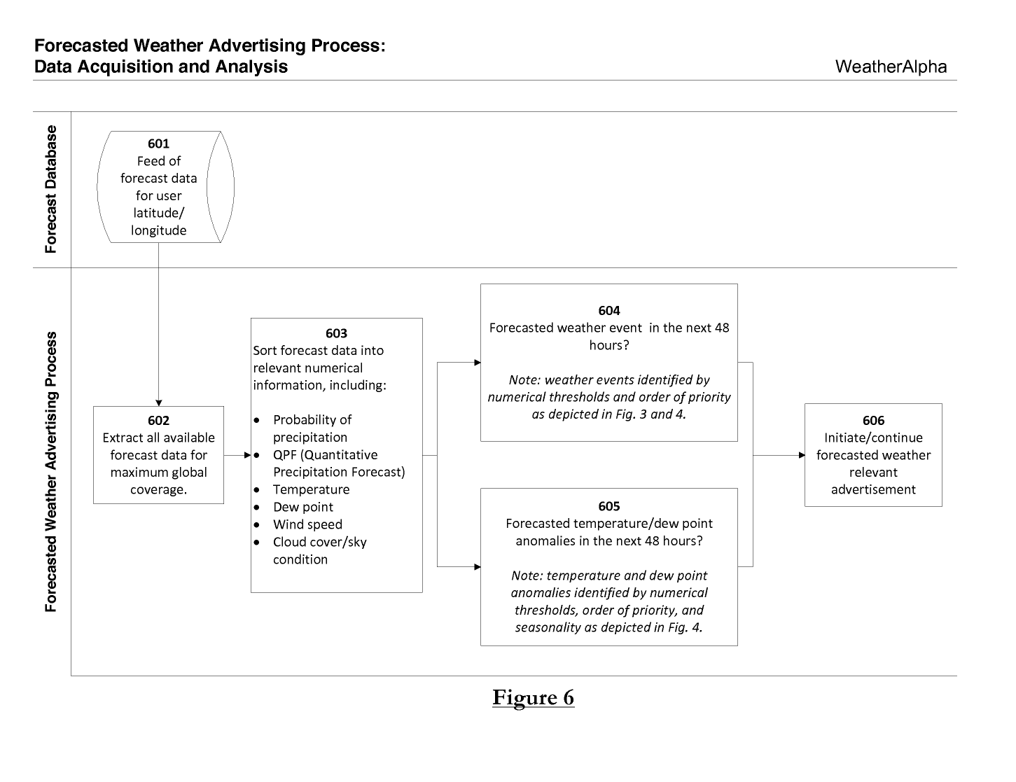

FIG. 6 shows an embodiment where the advertisement process is triggered by forecasted weather conditions. As with the current weather triggering processes, the first step is to extract 602 forecast data for the closest forecast location 601 to the viewer. This data 603 may take—but is not limited to—one of the following forms: a feed of gridded text variables, raw output from one or more computer models, or an interpolation of a plotted (automatic or manual) atmospheric field—such as temperature or Quantitative Precipitation Forecast (QPF). If a future weather event is forecasted 604, using the order of priority and threshold analysis in FIGS. 3 and 4, the DCMS triggers a weather relevant advertisement 606 for that forecasted weather event. However, unlike the current weather event triggers which are based upon observations, forecasted weather events are triggered by other numerical thresholds contained in the forecasts. For example, a current rain advertisement is triggered when an observation shows rain of a given intensity at the nearest weather station—but a forecasted rain advertisement is triggered by a probability threshold. Likewise, future temperature and dew point advertisements would be triggered when the DCMS identified forecasted temperature and dew point anomalies 605 in the forecast data. These anomaly thresholds would be the same as those displayed in FIG. 5. Also, while the processes detailed by FIG. 6 show forecasts for up to 48 hours, the DCMS has the capacity to use forecasts for time intervals beyond 48 hours, such a 96 hours, 7 days, or any other period and trigger advertisements accordingly.

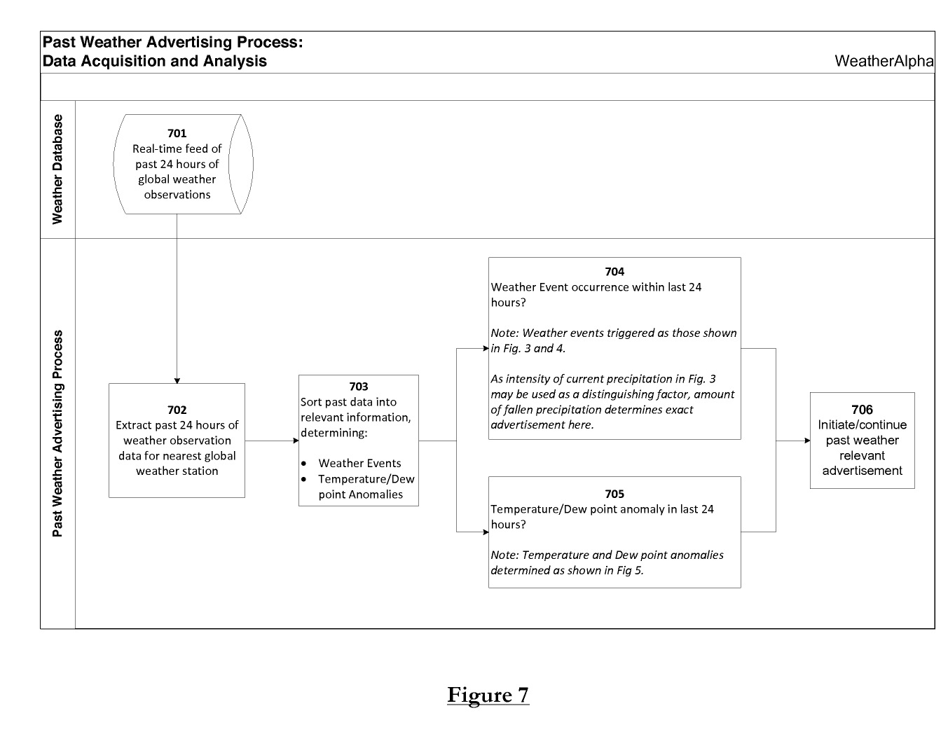

FIG. 7 shows an embodiment of the advertising process as triggered by past weather conditions. From a database of past weather observations 701, the DCMS extracts relevant weather data from the weather station 702 nearest to the viewer's identified geolocation. After sorting 703 into the same discrete weather variables as discussed in prior processes, the DCMS identifies the existence of a weather event 704 or temperature/dew point anomaly 705 and triggers an appropriate advertisement 706 to account for past weather conditions. An advertisement example is a snow blower advertisement in the wake of a departing snowstorm or a flood insurance advertisement after excessive rains. The triggers for weather events and temperature/dew point anomalies are approximately the same as described by FIGS. 3, 4, and 5. However, in the case of precipitation, magnitude distinctions are made based on total observed precipitation rather than current intensity of precipitation. Lastly, while the processes in this example figure use a temporal window of 24 hours, the past advertising process use a window of 48 hours, 7 days, or any other period for weather event or temperature/dew point anomalies, depending on user preferences.

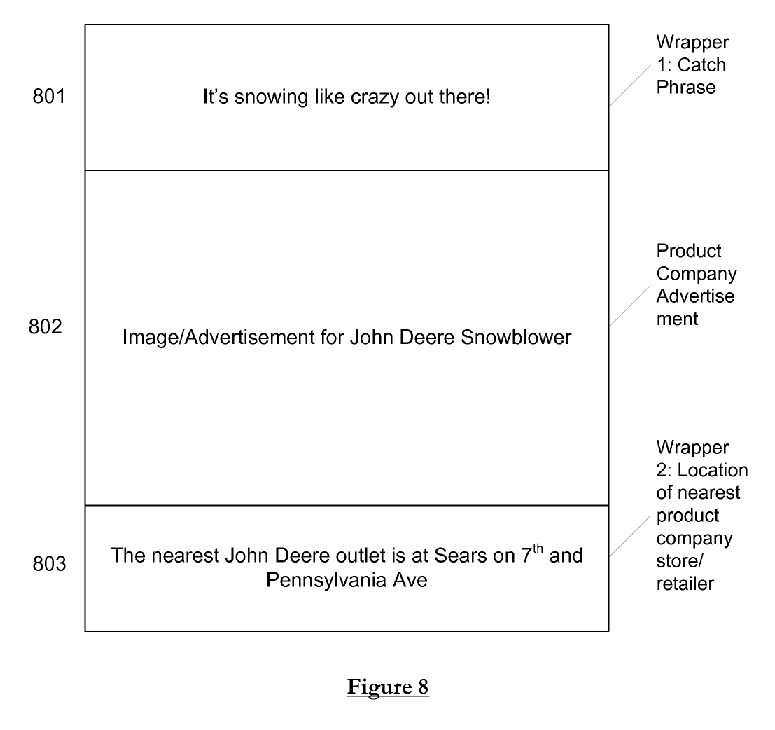

FIG. 8 is a hypothetical snow blower advertisement triggered by heavy falling snow. It contains three components—a catch phrase corresponding to the current weather conditions above the advertisement, or top wrapper 801, a display or advertisement for the product itself 802, and the nearest location where that product can be purchased—the bottom wrapper 803.

What is claimed is:

1. A computerized method of analyzing weather data to improve the selection of contextually relevant communication, the method comprising:
receiving passive geolocation information,
receiving weather data relevant to the location,
analyzing the weather data to identify a weather condition,
accessing a database containing a plurality of available advertisements assigned to weather conditions,
selecting a communication associated with the identified weather condition.

2. The method of claim 1, further comprising, providing the selected communication to a remote display device.

3. The method of claim 2, further comprising, instructing a communications platform to display or rotate an advertisement.

4. The method of claim 1, where the “receiving weather data” step includes receiving current weather data.

5. The method of claim 4, wherein the received current weather data includes METAR codes.

6. The method of claim 4, where the current weather data includes data received from a radar based weather database.

7. The method of claim 6, where the current weather data further includes data received from an observation based weather database, and, such observation based data is used to confirm and refine the radar-sourced data.

8. The method of claim 1, where the “receiving weather data” step includes receiving:
recent historical weather data.

9. The method of claim 1, where the “receiving weather data” step includes receiving:
forecasted weather data.

10. The method of claim 1, where the “receiving weather data” step includes receiving: climatological weather data.

11. The method of claim 1, wherein,
a. the “receiving weather data” step includes receiving:
i. current temperature information, and
ii. climatological data; and
b. the “analyzing the weather data” step includes a temperature threshold analysis, wherein,
i. a temperature-anomaly weather condition is identified if the current temperature is above or below the climatological mean temperature for the date, time and location at which the communication is to be displayed.

12. The method of claim 1, wherein,
a. the “receiving weather data” step includes receiving:
i. current temperature information, and
ii. climatological data; and
b. the “analyzing the weather data” step includes a temperature threshold analysis, wherein,
i. a temperature-anomaly weather condition is identified if the current temperature is at least 5 degrees above or below the climatological mean temperature for the date, time and location at which the communication is to be displayed.

13. The method of claim 1, wherein,
a. the “receiving weather data” step includes receiving:
i. current temperature information, and
ii. climatological data; and
b. the “analyzing the weather data” step includes a temperature threshold analysis, wherein,
i. a temperature-anomaly weather condition is identified if the season is spring or summer and the temperature is at least 5 degrees above the climatological mean temperature for the date, time and location at which the communication is to be displayed.

14. The method of claim 1, wherein,
a. the “receiving weather data” step includes receiving:
i. current temperature information, and
ii. climatological data; and
b. the “analyzing the weather data” step includes a temperature threshold analysis, wherein,
i. a temperature-anomaly weather condition is identified if the season is fall or winter and the temperature is at least 5 degrees below the climatological mean temperature for the date, time and location at which the communication is to be displayed.

15. The method of claim 1, wherein,
a. the “receiving weather data” step includes receiving:
i. current temperature information, and
ii. climatological data; and
b. the “analyzing the weather data” step includes a temperature threshold analysis, wherein,
i. a record-temperature-anomaly weather condition is identified if the temperature sets a record high or record low temperature for the date, time and location at which the advertisement is to be displayed.

16. The method of claim 1, wherein,
a. the “analyzing” step includes identifying the existence of weather conditions including:
rain, snow, ice, anomalous heat, anomalous cold, or wind; and
b. the “selecting” step includes using the existence of a weather condition to trigger the selection of a communication assigned to the identified weather condition.

17. The method of claim 16, wherein,
a. the “analyzing” step includes determining the magnitude of the identified weather condition, and,
b. the “selecting” step includes using the magnitude of the identified weather condition as a weighted factor in selecting an advertisement.

18. The method of claim 1, wherein,
a. the “received weather data” includes current weather data, and,
b. the “analyzing” step includes identifying the type of precipitation.

19. The method of claim 1, wherein,
a. the “received weather data” includes current weather data, and,
b. the “analyzing” step includes identifying the existence of rain, snow, hail, freezing rain or sleet.

20. The method of claim 19, wherein the weather data analysis step includes:
c. the “received weather data” includes current observation data, and
d. the “analyzing” step includes using the observation data to confirm and refine the weather condition identified using other weather data.

21. The method of claim 1, wherein,
e. “receiving weather data” includes
i. receiving current radar data, and
ii. receiving current observation data; and
f. the “analyzing” step includes,
i. identifying the type of precipitation through the radar data,
ii. confirming the radar data identification with observation data.

22. The method of claim 1, wherein
g. the “receiving weather data” step includes receiving METAR codes, and,
h. the “analyzing” step includes using the METAR code to identify the existence and intensity of a rain or snow type weather condition.

23. The method of claim 1, wherein,
i. the “receiving weather data” step includes receiving current and climatological weather data, and
j. the “analyzing” step includes using the radar data to identify the existence, type and rate of a precipitation weather condition, and
k. comparing the rate of precipitation to the climatological precipitation norms for the date time and location at which the communication is to be displayed.

24. The method of claim 1, wherein the “analyzing” step includes: identifying the magnitude of the weather condition.

25. The method of claim 1, wherein,
l. the “receiving weather data” step includes receiving dew point and temperature information; and,
m. the “analyzing” step includes analyzing dew point data for an anomalously high or low dew point.

26. The method of claim 1, wherein the “analyzing” step includes: determining forecasted duration and forecasted intensity of the predicted weather condition.

27. The method of claim 1, wherein the communication includes an advertisement for goods or services and the location of a retailer or service provider conveniently accessible to a person at the identified geographic location.

28. A method of analyzing weather data to improve the selection of contextually relevant communication, comprising:
a. receiving passive geolocation information,
b. receiving weather data relevant to the location,
c. analyzing the weather data to identify a weather condition,
d. using the identified weather condition as a factor in selecting an advertisement,
e. providing the selected communication to a remote display device.

29. A method of providing targeted contextual communications, comprising:
a. Receiving passive geolocation information,
b. receiving weather data relevant to the geolocation,
c. analyzing the weather data,
d. accessing a database containing a plurality of available communications,
e. using the results of the weather analysis as a factor in generating a contextual advertisement wrapper,
f. providing the selected communication to a remote display device.

30. A computerized system for selecting targeted contextual communications, the system comprising:
a processor and a memory, the processor executing the steps comprising:
a. receiving passive geolocation information,
b. receiving weather data relevant to the geolocation,
c. analyzing the weather data to determine one or more weather factors,
d. accessing a database containing a plurality of available communications,
e. weighting the one or more weather factors based on rules associated with the plurality of available communications,
f. selecting one or more available communications based on the rules;
g. prioritizing the selected one or more available communications based on user preferences to determine one or more provided communications;
h. providing the one or more provided communication to a remote display device.
